(19) United States
(12) Patent Application Publication
(10) Pub. No.: US 2009/0290763 A1
(43) Pub. Date: Nov. 26, 2009

(54) VEIN AUTHENTICATION APPARATUS AND VEIN AUTHENTICATION METHOD

(76) Inventor: Hiroshi ABE, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/468,492

(22) Filed: May 19, 2009

(30) Foreign Application Priority Data
May 21, 2008 (JP) P2008-133484

(51) Int. Cl. G06K 9/00

(52) U.S. Cl. 382/115

(57) ABSTRACT

According to the present invention, there is provided a vein authentication apparatus including an imaging unit that generates a plurality of pieces of vein imaged data, a vein pattern extraction unit that extracts a vein pattern from each of a plurality of pieces of vein imaged data, a rotation amount calculation unit that calculates a rotation direction and a rotation amount of a finger accompanying a rotational motion of each extracted vein pattern, and a registration information selection unit that selects the vein pattern to be registered as a template from a plurality of the vein patterns to make the vein pattern registration information if, after calculating a shift amount of the imaging range and determining whether a shift width of the imaging range is equal to or more than a predetermined threshold, the shift width of the imaging range is less than the predetermined threshold.

### BACKGROUND OF THE INVENTION

1. Field of the Invention

The present invention relates to a vein authentication apparatus and a vein authentication method.

2. Description of the Related Art

In recent years, with the advancement of information communication technology, it has becomes possible to use various services such as electronic money and a commuter pass with a mobile terminal such as a PDA (Personal Digital Assistant) and a mobile device such as a mobile phone. Various authentication methods can be used to guarantee safety when using such services.

Vein authentication technology in which personal authentication is performed by using vein patterns that can be obtained by imaging a portion of the body is known as one of such authentication methods. The vein authentication is expected to be next-generation biometric personal authentication because of high determination precision thereof and difficulty of falsification and impersonation.

In biometric personal authentication, however, the same information is not necessarily input every time due to changes of environment or biometric state at an authentication, and it is necessary to probabilistically assume input in the range of a certain distribution. Thus, it is difficult to perform authentication processing steadily with uniform template information.

Therefore, a method of steadily performing authentication by retaining different patterns obtained by rotating a finger slightly around an axis set as the length direction of the finger as templates (see, for example, Japanese Patent Application Laid-Open No. 2007-213427).

### SUMMARY OF THE INVENTION

However, according to a method described in Japanese Patent Application Laid-Open No. 2007-213427, while there is no particular burden on a user during authentication, there is an issue that a user interface is such that it is unavoidable to demand an unreasonable motion or to force the user one-sidedly to make a motion during registration.

Thus, the present invention has been made in view of the above issue, and it is desirable to provide a vein authentication apparatus and a vein authentication method capable of acquiring template data in which steadily different rotational shifts occur without a user being forced to make an unreasonable motion and also acquiring a template that can realize steady authentication processing.

According to an embodiment of the present invention, there is provided a vein authentication apparatus, including a light source unit that irradiates a surface of a finger making a rotational motion around an axis along a length direction with a near infrared light of a predetermined wavelength, an imaging unit that images the surface of the finger irradiated with the near infrared light at predetermined intervals to generate a plurality of pieces of vein imaged data whose imaging range is mutually different, a vein pattern extraction unit that extracts a vein pattern from each of the plurality of pieces of vein imaged data, a rotation amount calculation unit that calculates a rotation direction and a rotation amount of the finger accompanying the rotational motion of each of the extracted vein patterns relative to the imaging range of one of the vein patterns, and a registration information selection unit that selects the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.

According to such a configuration, the light source unit irradiates a surface of a finger making a rotational motion around an axis along a length direction with a near infrared light of a predetermined wavelength, the imaging unit images the surface of the finger irradiated with the near infrared light at predetermined intervals to generate a plurality of pieces of vein imaged data whose imaging range is mutually different, and the vein pattern extraction unit extracts a vein pattern from each of the plurality of pieces of vein imaged data. The rotation amount calculation unit calculates a rotation direction and a rotation amount of the finger accompanying the rotational motion of each of the extracted vein patterns relative to the imaging range of one of the vein patterns. The registration information selection unit selects the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.

It is preferable that the registration information selection unit retains the vein patterns positioned at both ends of the imaging range and selects from among the vein patterns present between the vein patterns positioned at both ends the vein patterns positioned in such a way that distances to the adjacent vein patterns are close to being substantially equal.

The vein authentication apparatus may further include a vein pattern authentication unit that authenticates the extracted vein pattern based on the registration information registered as the template, wherein the registration information selection unit may update content of the registered registration information using the registration information and the authenticated vein pattern.

The rotation amount calculation unit may calculate correlation coefficients between the one vein pattern to be the reference and the other vein patterns to calculate the rotation direction and the rotation amount based on a shift direction and the shift amount of a peak position of the correlation coefficients.

The threshold of the shift width of the imaging range may be 10% of a pixel amount representing the imaging range of the one vein pattern to be the reference.

According to another embodiment of the present invention, there is provided a vein authentication method, including the steps of: irradiating a surface of a finger making a rotational motion around an axis along a length direction with a near infrared light of a predetermined wavelength; imaging the surface of the finger irradiated with the near infrared light at predetermined intervals to generate a plurality of pieces of vein imaged data whose imaging range is mutually different; extracting a vein pattern from each of the plurality of pieces of vein imaged data; calculating a rotation direction and a rotation amount of the finger accompanying the rotational motion of each of the extracted vein patterns relative to the imaging range of one of the vein patterns; and selecting the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.

According to the embodiments of the present invention described above, template data in which steadily different rotational shifts occur without a user being forced to make an unreasonable motion can be acquired and also a template that can realize steady authentication processing can be acquired.

### BRIEF DESCRIPTION OF THE DRAWINGS

FIG. 1A is an explanatory view illustrating an outline of a vein authentication method according to a first embodiment of the present invention;

FIG. 1B is an explanatory view illustrating the outline of the vein authentication method according to the embodiment;

FIG. 2 is an explanatory view illustrating the outline of the vein authentication method according to the embodiment;

FIG. 3A is an explanatory view illustrating the outline of the vein authentication method according to the embodiment;

FIG. 3B is an explanatory view illustrating the outline of the vein authentication method according to the embodiment;

FIG. 4 is a block diagram illustrating a configuration of a vein authentication apparatus according to the embodiment;

FIG. 5 is an explanatory view illustrating a rotation direction and a calculation of a rotation amount;

FIG. 6 is an explanatory view illustrating selection processing of registration information performed by the vein authentication apparatus according to the embodiment;

FIG. 7 is an explanatory view illustrating the selection processing of registration information performed by the vein authentication apparatus according to the embodiment;

FIG. 8 is an explanatory view illustrating the selection processing of registration information performed by the vein authentication apparatus according to the embodiment;

FIG. 9A is an explanatory view illustrating the selection processing of registration information performed by the vein authentication apparatus according to the embodiment;

FIG. 9B is an explanatory view illustrating the selection processing of registration information performed by the vein authentication apparatus according to the embodiment;

FIG. 10 is an explanatory view illustrating the selection processing of registration information performed by the vein authentication apparatus according to the embodiment;

FIG. 11 is a flow chart illustrating the vein authentication method according to the embodiment;

FIG. 12 is a flow chart illustrating the selection processing of registration information performed by the vein authentication apparatus according to the embodiment;

FIG. 13 is an explanatory view illustrating an update of registration information during authentication processing;

FIG. 14 is a flow chart illustrating an update method of registration information during authentication processing;

FIG. 15 is a block diagram illustrating a hardware configuration of an information processing apparatus according to the embodiment;

FIG. 16 is an explanatory view illustrating a registration method of a template according to a information processing method in related art; and

FIG. 17 is a flow chart illustrating the registration method of the template according to the information processing method in related art.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

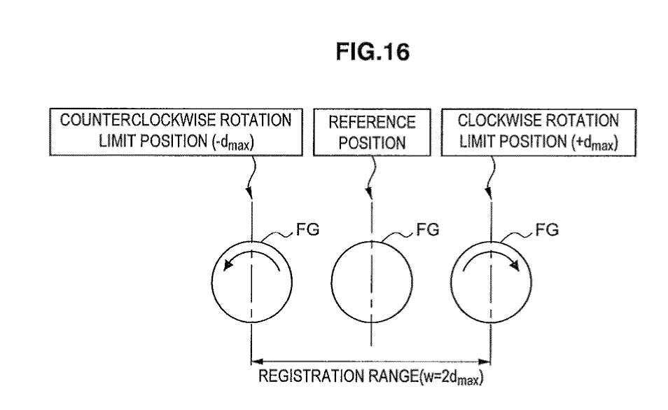

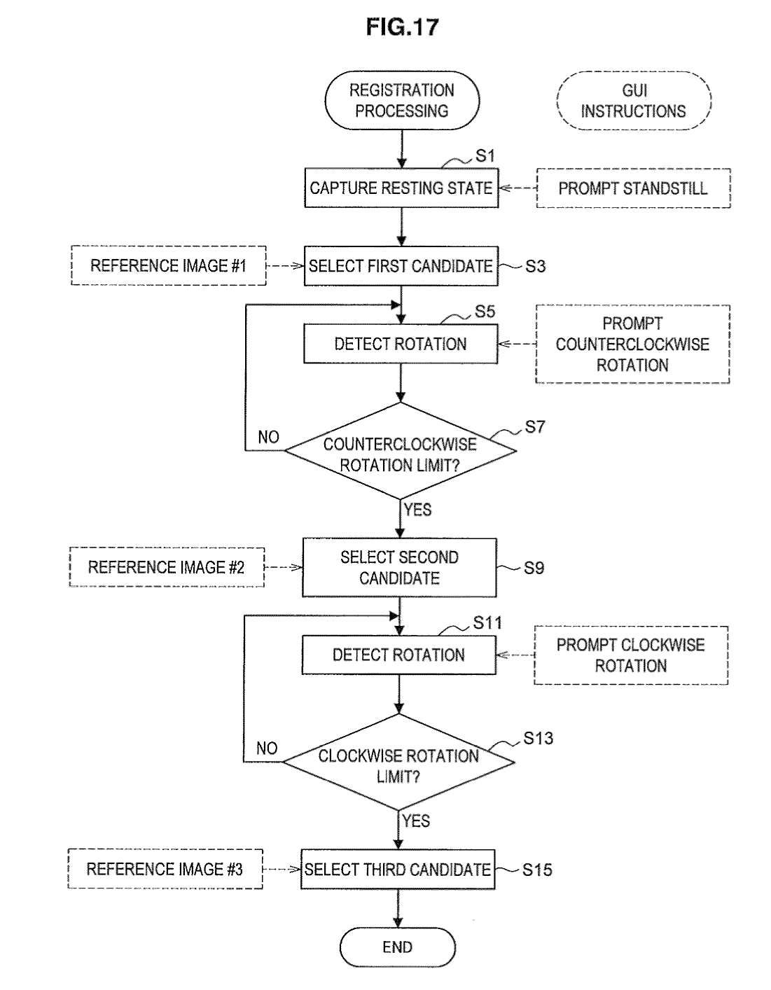

Before starting to describe a vein authentication apparatus and a vein authentication method according to each embodiment of the present invention, issues of a vein authentication method in related art will be described with reference to FIG. 16 and FIG. 17.

FIG. 16 is an explanatory view illustrating a registration method of a template according to a information processing method in related art, and FIG. 17 is a flow chart illustrating the registration method of the template according to the information processing method in related art.

As an example of the registration method of a template in related art, for example, a method of acquiring different rotation shifts as template data after acquiring a total of three images (left, center, and right) will be described below.

According to this method, as shown in FIG. 16, a reference template is first determined. That is, a state in which a finger is at rest is captured and defined as a reference position and a reference template is generated from an image in this state. A finger in a resting state refers to an imaging frame unit and here, no burden is placed on the user. Next, as shown in FIG. 16, template data is registered as a reference image at a position where a preset rotation is obtained (that is, rotation limit positions on the right and left ±dₘₐₓ) after being rotated clockwise or counterclockwise from the reference position. In the method in related art, the registration range wₜₕᵣ of rotation shifts is 2dₘₐₓ.

A flow chart of the registration method of template data will be described below with reference to FIG. 17.

According to the method in related art, the user is prompted to rest his (her) finger by displaying a GUI (Graphical User Interface) prompting the user to rest his (her) finger on the display screen (step S1). Then, according to the method in related art, the surface of the finger is imaged to create the first piece of imaged data and the data is selected as the first candidate (step S3).

Next, according to the method in related art, a message to prompt the user to rotate his (her) finger counterclockwise is displayed on the display screen and whether the finger is actually rotated is detected (step S5). When the rotation amount reaches a limit thereof (step S7), according to the method in related art, the surface of the finger is imaged to create the second piece of imaged data and the data is selected as the second candidate (step S9).

Next, according to the method in related art, a message to prompt the user to rotate his (her) finger clockwise is displayed on the display screen and whether the finger is actually rotated is detected (step S5). When the rotation amount reaches a limit thereof (step S7), according to the method in related art, the surface of the finger is imaged to create the third piece of imaged data and the data is selected as the third candidate (step S9).

In this case, as described above, an action of rotating a finger that is usually not often used is performed under GUI instructions of an application. If the order of clockwise/counterclockwise rotation is preset, the procedure becomes more complicated and further, there may be a rotation direction in which some people have difficulty in rotating their finger in that direction. Such a very burdensome action itself for the 1user could be an obstacle to usage.

Thus, in the vein authentication apparatus and vein authentication method according to each embodiment of the present invention described below, what is forced on the user to do is reduced and the GUI and registration processing are not linked so as to extract information necessary for registration in a free motion of the user.

The description that follows takes a case of acquiring three pieces of template data as an example, but processing can similarly be performed in the vein authentication apparatus and vein authentication method according to each embodiment of the present invention if three or more pieces of template data are acquired.

### First Embodiment

### Outline of the Vein Authentication Method According to the Present Embodiment

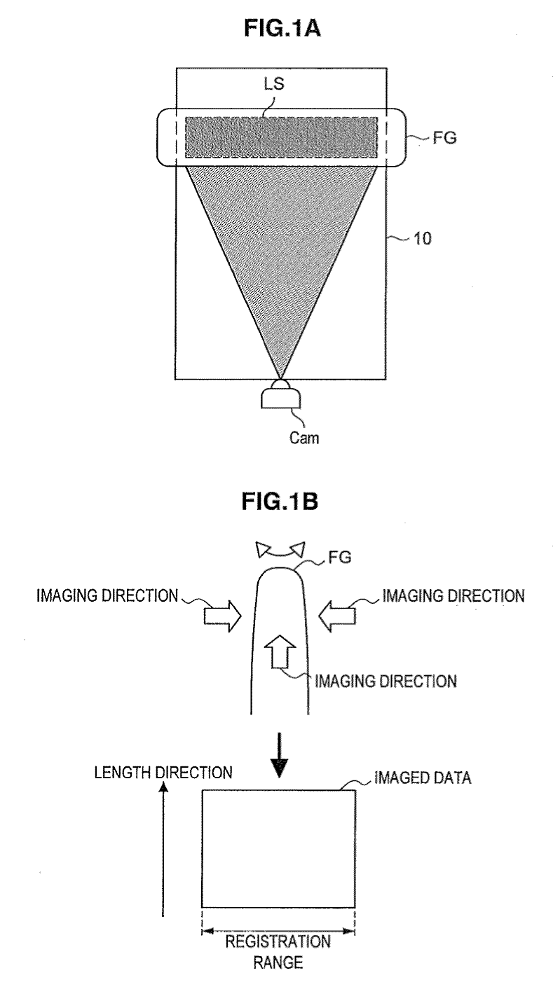

An outline of the vein authentication method according to the present embodiment will be described below with reference to FIG. 1A to FIG. 3B. FIG. 1A to FIG. 3B are explanatory views illustrating an outline of the vein authentication method according to the present embodiment.

In the vein authentication method according to the present embodiment, as shown in FIG. 1A, a finger surface FG is arranged over a light source unit LS of a vein authentication apparatus 10 is imaged by an image sensor Cam and a vein pattern is extracted. When imaging finger surface FG, the user rotates the finger around a rotation axis along the length direction while the axis is almost fixed. As a result, the finger of the user will be present without being translated near the light source unit LS.

If the finger is imaged in this state, the finger to be imaged will be imaged, as shown in FIG. 1B, from various directions and, as a result, imaged data having the predetermined spread in the width direction is obtained while the size in the length direction is almost constant. The width of the imaged data becomes the registration range to be registered as a template.

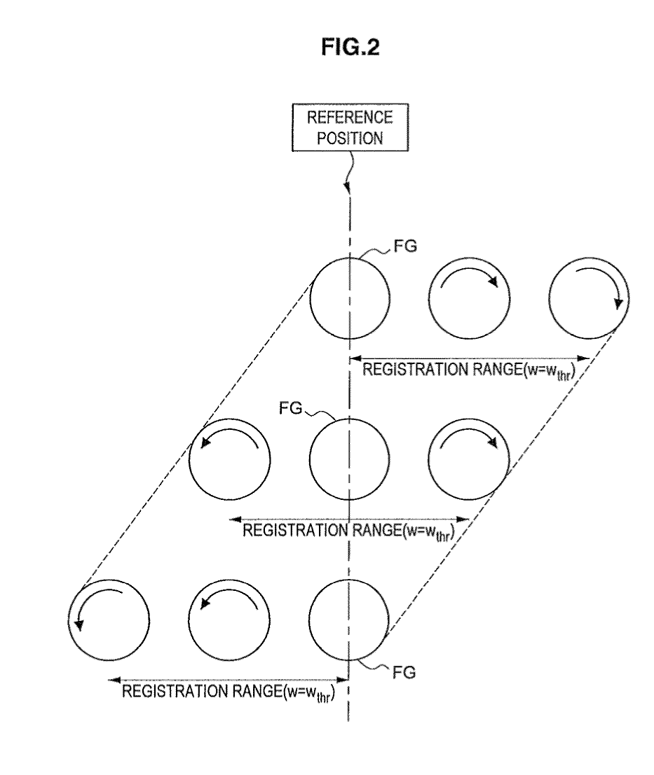

Next, the rotational motion of the finger in the vein authentication method according to the present embodiment will be described with reference to FIG. 2. The figures shown below all illustrate the translation amount (in other words, the length of an arc by rotation) of an image picked up in an imaging range as a finger motion while the rotation axis is almost fixed and does not show that the finger itself is being translated.

In the vein authentication method according to the present embodiment, it is necessary to retain a history of imaging with respect to the user's motion. Here, it is necessary first to capture the resting state and then, based on a reference template obtained from the resting state, a position shift is captured from a free motion of the user and the position thereof will be retained as history. However, it is not necessary to retain all position shifts and only when a position shift that extends the registration range arises, the held history needs to be updated.

Thus, in contrast to technology in related art, as shown in FIG. 2, as long as the registration range can be covered, it makes no difference whether the finger is rotated clockwise and counterclockwise relative to the resting state or rotated only in one direction of clockwise or counterclockwise from the resting state.

According to this method, even if it is difficult to rotate the finger clockwise or counterclockwise depending on the finger, a template can still be registered by rotating the finger in one direction alone. In the vein authentication method according to the present embodiment, the rotation direction is not forced on the user working together with the GUI and a mechanism in which the user can register a template by freely rotating the finger while viewing video showing a registration scene can be constructed.

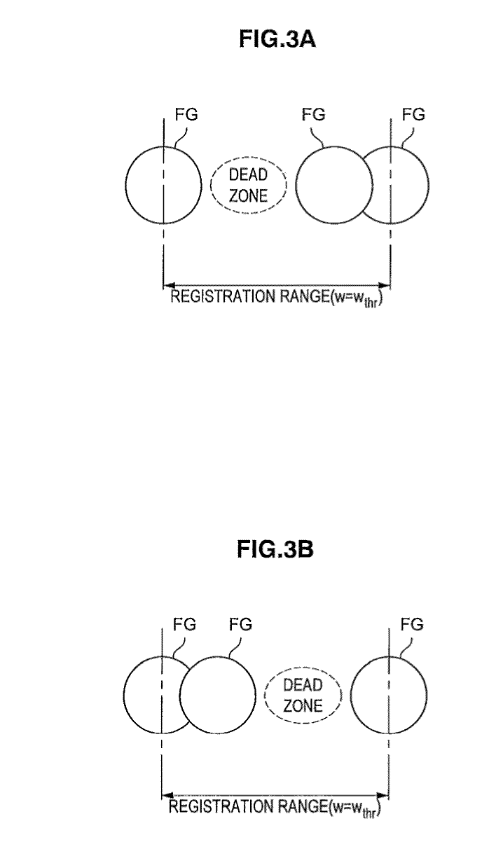

Next, the method of retaining a history of position shifts will be described with reference to FIG. 3A and FIG. 3B.

According to the method in related art, limit positions on the right and left are provided by working together with the GUI and thus, three pieces of template data clearly have position shifts by retaining a substantially central position and limit positions on the right and left so that the registration range can be covered almost equally.

However, in the method according to the present embodiment, no limit positions on the right and left are provided working together with the GUI. Thus, the history needs to be updated only when a position shift in a direction extending the registration range occurs from among position shift data changing every moment and how to select the central position (not necessarily the reference position) sandwiched by the limit positions on the right and left at this point becomes important.

That is, as shown in FIG. 3A and FIG. 3B, if the center is selected incorrectly, template data may be lopsided data and the arrangement position of the template data may become unequal, creating blank positions called dead zone. If a plurality of templates as shown in FIG. 3A or FIG. 3B is registered, there is a possibility that it becomes difficult to pass authentication when a vein pattern tilted toward a direction opposite to the lopsided side is presented.

Thus, in the vein authentication method according to the present embodiment, a history of vein patterns imaged and extracted so as to be able to equally cover the registration range depending on the number of templates is retained and used as template data.

### <Configuration of the Vein Authentication Apparatus>

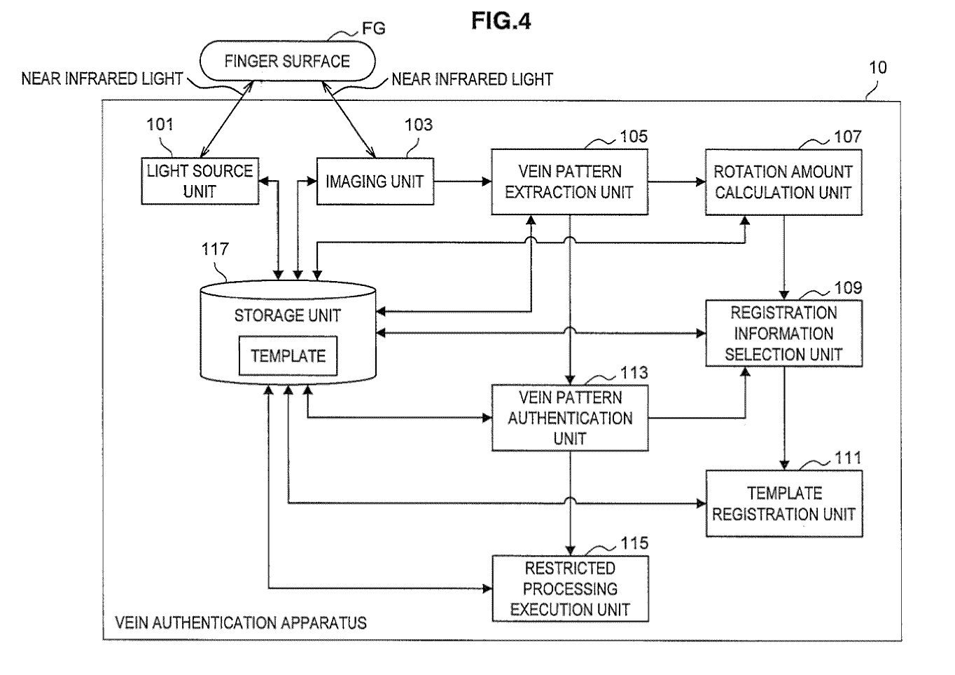

Subsequently, the configuration of the vein authentication apparatus 10 according to the present embodiment will be described in detail with reference to FIG. 4. FIG. 4 is a block diagram illustrating a configuration of a vein authentication apparatus according to the embodiment.

The vein authentication apparatus 10 according to the present embodiment mainly includes, as shown in FIG. 4, a light source unit 101, an imaging unit 103, a vein pattern extraction unit 105, a rotation amount calculation unit 107, a registration information selection unit 109, a template registration unit 111, a vein pattern authentication unit 113, a restricted processing execution unit 115, and a storage unit 115.

The light source unit 101 irradiates a body surface (for example, the finger surface) FG with a near infrared light having a predetermined wavelength band. The near infrared light has features of being absorbed by hemoglobin (reduced hemoglobin) in blood while being passed through systems of the body easily and thus, if a finger, palm or instep is irradiated with a near infrared light, veins distributed inside the finger, palm or instep appear as a shadow in an image. A shadow of veins appearing in an image is called a vein pattern. In order to image such an excellent vein pattern, the wavelength of a near infrared light irradiated by the light source unit 101 of a light emitting diode or the like is about 600 nm to 1300 nm, preferably 700 nm to 900 nm.

Here, if the wavelength of a near infrared light irradiated by the light source unit 101 is less than 600 nm or more than 1300 nm, the ratio of the near infrared light absorbed by hemoglobin becomes smaller, making it difficult to obtain an excellent vein pattern. If the wavelength of a near infrared light irradiated by the light source unit 101 is about 700 nm to 900 nm, the near infrared light is specifically absorbed by both deoxygenated hemoglobin and oxygenated hemoglobin and thus, an excellent vein pattern can be obtained.

Instead of using a light emitting diode having the wavelength band as described above, a combination of a light emitting diode capable of emitting light in the aforementioned wavelength band and a filter that optically limits the band of emitted light may be used.

A near infrared light emitted from the light source unit 101 propagates toward the finger surface FG and enters the body from a side thereof or the like as a direct light. Here, since the body is an excellent scatterer of near infrared light, the direct light that enters the body propagates while being scattered in all directions. The near infrared light that has passed through the body will enter an optical element of the imaging unit 103.

The imaging unit 103 includes an optical system including an imaging element such as a CCD (Charge Coupled Device) and CMOS (Complementary Metal Oxide Semiconductor) and optical element such as lenses, an imaging control unit (not shown) that includes a. CPU (Central Processing Unit), a ROM (Read Only Memory), and a RAM (Random Access Memory) and controls driving of the optical system.

The optical system included in the imaging unit 103 includes one or a plurality of optical elements and one or a plurality of imaging elements. The optical system of the imaging unit 103 according to the present embodiment may be dedicated to vein authentication processing or a preexisting optical system may be used as a vein imaging optical system. For example, when the vein authentication apparatus 10 according to the present embodiment is implemented in a mobile device such as a mobile phone, an optical system pre-implemented in the optical system can be used as a vein imaging optical system.

It is known that a human skin has a three-layer structure of a surface skin, dermic layer, and hypodermal tissue and the venation where veins are present is located in the dermic layer. The dermic layer is a layer present about 0.1 mm to 0.3 mm from the finger surface with a thickness of about 2 mm to 3 mm. Therefore, by setting the focal position of an optical element such as a lens to the position where the dermic layer is present (for example, about 1.5 mm to 2.0 mm from the finger surface), transmitted light that has passed through the venation can efficiently be condensed.

The transmitted light condensed by the optical element after being passed through the venation is formed as an image on the imaging element to become vein imaged data.

The imaging control unit generates a plurality of pieces of imaged data by controlling the optical system and imaging element each time a predetermined time interval passes. The time interval for imaging the finger surface FG can be set to any value in accordance with processing capabilities and the like of the vein authentication apparatus 10 according to the present embodiment.

The imaging control unit outputs imaged data generated by the imaging element to the vein pattern extraction unit 105 described later. The imaging control unit also may record obtained imaged data in the storage unit 117 described later. When recording in the storage unit 117, the imaging control unit may associate the imaging date, imaging time and the like with the generated imaged data. Imaged data to be generated may be a RGB (Red-Green-Blue) signal or image data of colors other than RGB or gray scale.

The imaging unit 103 according to the present embodiment may be a so-called transmission type imaging unit that images a transmitted light irradiated from the light source unit 101 and passed through the finger or a so-called reflection type imaging unit that images a reflected light of a near infrared light reflected inside the finger.

The vein pattern extraction unit 105 includes, for example, the CPU, ROM, RAM and the like and has, for example, a function to perform preprocessing of vein pattern extraction on near infrared light imaged data transmitted from the imaging unit 103, that of extracting a vein pattern, and that of performing post-processing of vein pattern extraction.

Here, the preprocessing of vein pattern extraction includes, for example, processing to identify the position of finger in imaged data by detecting an outline of the finger from the imaged data, processing to correct the angle of imaged data (angle of the pick-up image) by rotating the imaged data in a plane using the outline of the detected finger.

The vein pattern extraction is performed by applying a differential filter to imaged data for which outline detection and angle corrections are completed. The differential filter is a filter that outputs a large value for a portion where a difference between a focused pixel and surrounding pixels is large as an output value. In other words, the differential filter is a filter that emphasizes lines or edges in an image by operations using a difference between a focused pixel and surrounding gradation values.

Generally, if filter processing is performed on image data u(x, y) having lattice points (x, y) in a two-dimensional plane as variables by using a filter h(x, y), as shown in Formula 1 shown below, image data v(x, y) is generated. In the following Formula 1 shown below, “*” represents convolution.

$$\begin{matrix}v ( x , y ) = u ( x , y ) * h ( x , y ) \\ = {\sum }_{{m}_{1}} {\sum }_{{m}_{2}} h ( {m}_{1} , {m}_{2} ) u ( x - {m}_{1} , y - {m}_{2} ) \\ = {\sum }_{{m}_{1}} {\sum }_{{m}_{2}} u ( {m}_{1} , {m}_{2} ) h ( x - {m}_{1} , y - {m}_{2} )\end{matrix} \qquad ( Formula 1 )$$

In the vein pattern extraction according to the present embodiment, a differential filter such as a primary space differential filter and a secondary space differential filter may be used as the differential filter. The primary space differential filter is a filter that calculates a difference of the gradation value of neighboring pixels in the horizontal and vertical directions with respect to a focused pixel, and the secondary space differential filter is a filter that extracts a portion where variations in difference of the gradation value with respect to the focused pixel are large.

A Log (Laplacian of Gaussian) filter shown below, for example, can be used as the secondary space differential filter. The Log filter (Formula 3) is represented as a second derivative of a Gaussian filter (Formula 2), which is a smoothing filter using a Gaussian function. Here, in Formula 2 shown below, or is the standard deviation of the Gaussian function and is a parameter representing the degree of smoothing of the Gaussian filter, σ in Formula 3 shown below is like σ in Formula 2, a parameter representing the standard deviation of the Gaussian function and an output value when Log filter processing is performed can be changed by changing the value of σ.

$$\begin{matrix}{h}_{gauss} ( x , y ) = \frac{1}{2 {πσ}^{2}} exp \{ - \frac{( {x}^{2} + {y}^{2} )}{2 {σ}^{2}} \} & ( Formula 2 ) \\ \begin{matrix}{h}_{log} ( x , y ) = {∇}^{2} \cdot {h}_{gauss} ( x , y ) \\ = ( \frac{{\partial }^{2}}{\partial {x}^{2}} + \frac{{\partial }^{2}}{\partial {y}^{2}} ) {h}_{gauss} \\ = \frac{( {x}^{2} + {y}^{2} - 2 σ )}{2 {πσ}^{6}} exp \{ - \frac{( {x}^{2} + {y}^{2} )}{2 {σ}^{2}} \}\end{matrix} & ( Formula 3 )\end{matrix}$$

The post-processing of the vein pattern extraction includes, for example, threshold processing performed on image data after the differential filter being applied, binarization processing, and processing to make lines narrower. After the post-processing being performed, it becomes possible to extract a skeleton of a vein pattern.

The vein pattern extraction unit 105 sends a vein pattern or skeleton extracted in this manner to the rotation amount calculation unit 107, the vein pattern authentication unit 113 or the like. The vein pattern extraction unit 105 may store the extracted vein pattern or skeleton in the storage unit 117 described later. Incidentally, the vein pattern extraction unit 105 may store parameters or processing performed halfway generated when each processing described above is performed in the storage unit 117.

The rotation amount calculation unit 107 includes, for example, the CPU, ROM, RAM and the like and selects one vein pattern from a plurality of vein patterns sent from the vein pattern extraction unit 105. This vein pattern is preferably the first vein pattern imaged in the resting state. The rotation amount calculation unit 107 calculates the rotation direction and rotation amount accompanying the rotational motion of each extracted vein pattern relative to the imaging range of the selected vein pattern. Various methods can be used as a method of calculating the rotation direction and rotation amount and, for example, the method shown below can be vised.

For example, the rotation direction and rotation amount can be calculated by calculating correlation coefficients between the vein pattern selected as the reference and other vein patterns other than the selected vein pattern.

A correlation coefficient is defined by Formula 4 shown below, is a statistical index showing a similarity between two pieces of data f1 and f2, and takes a real value ranging from −1 to 1. A correlation coefficient showing a value near 1 indicates that two pieces of data are similar and a correlation coefficient showing a value near 0 indicates that two pieces of data are not similar. When a correlation coefficient shows a value near −1, signs of two pieces of data are inverted or the like.

Here, it is assumed herein that f1 and f2 are data showing a vein pattern and have the image size of M rows and N columns. Further, a pixel of each vein pattern will be represented as (m, n).

$$S ( f 1 , f 2 ) = \frac{{\sum }_{m = 0}^{M - 1} {\sum }_{n = 0}^{N - 1} f 1 ( m , n ) \cdot f 2 ( m , n )}{\begin{matrix}\sqrt{\{ {\sum }_{m = 0}^{M - 1} {\sum }_{n = 0}^{N - 1} f 1 {( m , n )}^{2} \}} \\ \sqrt{\{ {\sum }_{m = 0}^{M - 1} {\sum }_{n = 0}^{N - 1} f 2 {( m , n )}^{2} \}}\end{matrix}} \qquad ( Formula 4 )$$

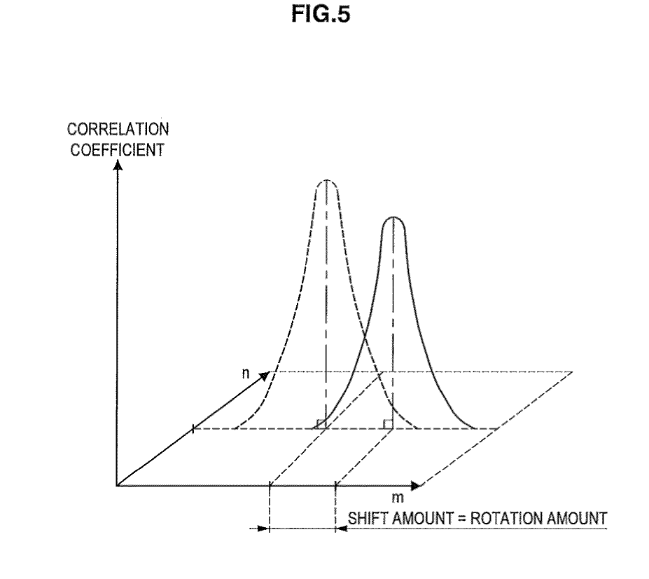

Here, if the two pieces of data f1 and f2 match perfectly, the value of the correlation coefficient thereof becomes 1 and the peak position thereof is, as shown in FIG. 5, a substantially central position of the mn plane. Thus, if a correlation coefficient is calculated as a vein pattern selected relative to both pieces of data f1 and f2, the value of the correlation coefficient thereof becomes 1 and the peak position thereof becomes the reference peak position when the rotation direction and rotation amount are calculated.

Next, a correlation coefficient will be calculated by assuming that the vein pattern selected as the reference is f1 and other vein patterns other than the selected vein pattern are f2. If the calculated correlation coefficient is equal to or more than a predetermined threshold, this means that it is highly probable that the other vein patterns other than the selected vein pattern are images actually obtained from a rotating finger. As shown by solid lines in FIG. 5, the direction of shift of the calculated peak position from the reference peak position corresponds to the rotation direction and the shift amount of the peak position corresponds to the rotation amount.

The rotation amount calculation unit 107 sends the calculated rotation direction and rotation amount to the registration information selection unit 109 described later. The rotation amount calculation unit 107 may store the calculated rotation direction and rotation amount in the storage unit 117 by associating with the relevant vein pattern.

The registration information selection unit 109 includes, for example, the CPU, ROM, RAM and the like and calculates the shift amount of the imaging range based on the rotation direction and rotation amount sent from the rotation amount calculation unit 107 to determine whether the shift width of the imaging range is equal to or more than a predetermined threshold. If the size of the generated vein pattern is, for example, length 160 pixels×width 160 pixels, the threshold can be set, for example, about 10% of the pixel amount representing the imaging range of the reference vein pattern, that is, about six pixels. The threshold of the shift width of the imaging range becomes the registration range (w=wₜₕᵣ) of templates containing rotation shifts.

Here, if, as a result of determination, the shift width of the imaging range is equal to or more than the predetermined threshold, the registration information selection unit 109 selects all extracted vein patterns as registration information and notifies the template registration unit 111 of the selection result.

If, as a result of determination, the shift width of the imaging range is less than the predetermined threshold, the registration information selection unit 109 selects as registration information vein patterns to be registered as templates. More specifically, the registration information selection unit 109 retains vein patterns positioned at both ends of the imaging range and selects from among vein patterns present between vein patterns positioned at both ends those vein patterns positioned in such a way that distances to adjacent vein patterns are close to being substantially equal.

The registration information selection unit 109 may also reexamine content of vein patterns registered as templates by using a vein pattern sent from the vein pattern authentication unit 113 described later after authentication to reselect registration information using the registered vein patterns and the vein pattern after authentication.

Selection processing of registration information performed by the registration information selection unit 109 will be described below in detail again.

The template registration unit 111 includes, for example, the CPU, ROM, RAM and the like and registers registration information (that is, a vein pattern) sent from the registration information selection unit 109 in the storage unit 117 described later as a template. When registering a registration vein pattern, not only the vein pattern, but also other data identifying the individual having the vein pattern (for example, fingerprint data, face image data, iris data, and voice print data) may be stored by associating with the vein pattern. The registration vein pattern to be registered as a template may have header information conforming to standards of, for example, CBEFF (Common Biometric Exchange File Format).

The vein pattern authentication unit 113 includes, for example, the CPU, ROM, RAM and the like and performs authentication of a generated vein pattern based on the vein pattern generated by the vein pattern extraction unit 105 and templates of recorded vein patterns. The vein pattern authentication unit 113 requests a disclosure of templates from the storage unit 117 and compares acquired templates and the vein pattern sent from the vein pattern extraction unit 105. Templates and the sent vein pattern can be compared, for example, based on a correlation coefficient shown in Formula 4 after the correlation coefficient being calculated. If, as a result of comparison, templates and the sent vein pattern are similar, the vein pattern authentication unit 113 authenticates the sent vein pattern and, if templates and the sent vein pattern are not similar, the vein pattern extraction unit 105 does not authenticate the sent vein pattern.

The vein pattern authentication unit 113 may store an authentication result in the storage unit 117 by associating with an authentication time or the like as an authentication history. By generating such an authentication history. It becomes possible to know who requested authentication of a vein pattern and when and eventually, who used the vein authentication apparatus 10 and when.

The vein pattern authentication unit 113 may notify the registration information selection unit 109 of a vein pattern whose authentication is successful so that the vein pattern is used to update registration information.

The restricted processing execution unit 115 includes, for example, the CPU, ROM, RAM and the like and performs the predetermined processing whose execution is restricted in accordance with an authentication result of the vein pattern output from the vein pattern authentication unit 113. That is, after receiving a notification that authentication of a vein pattern is successful from the vein pattern authentication unit 113, the restricted processing execution unit 115 lifts restrictions on execution of predetermined processing and performs the processing.

The storage unit 117 stores a registration vein pattern whose registration is requested by the template registration unit 111, other data associated with the registration vein pattern. In addition to the above data, the storage unit 117 can store imaged data generated by the imaging unit 103, and vein pattern extracted by the vein pattern extraction unit 105. Further, in addition to the above data, the storage unit 117 can store various parameters and processing performed halfway that become necessary to be stored when the vein authentication apparatus 10 performs some processing, various databases and the like when necessary. The storage unit 117 can freely be read and written to by the light source unit 101, the imaging unit 103, the vein pattern extraction unit 105, the rotation amount calculation unit 107, the registration information selection unit 109, the template registration unit 111, the vein pattern authentication unit 113, and the restricted processing execution unit 115.

In the foregoing, an example of functions of the vein authentication apparatus 10 according to the present invention has been described. Each of the components may be constructed from general-purpose members or circuits or from hardware tailored to functions of each component. Alternatively, all functions of each component may be performed by the CPU. Therefore, the configuration to be used can suitably be changed in accordance with the technical level when the present embodiment is carried out.

### <Selection Method of Registration Information>

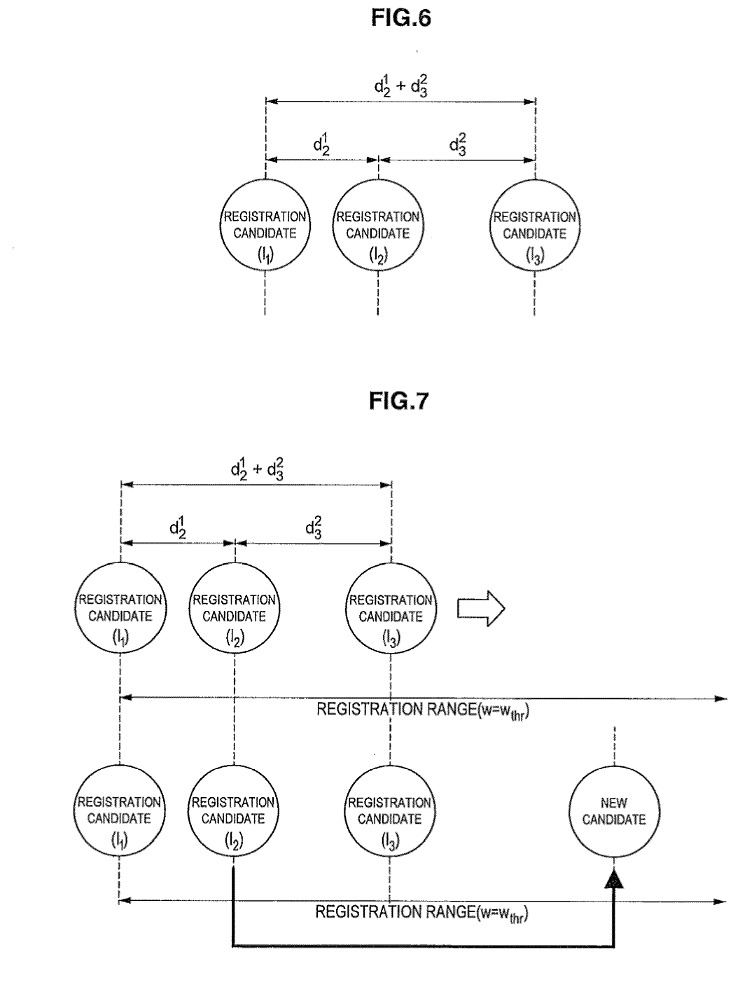

Next, the selection method of registration information performed by the registration information selection unit 109 of the vein authentication apparatus 10 according to the present embodiment will be described in detail with reference to FIG. 6 to FIG. 10.

Here, for simplicity's sake, the method when three vein patterns are registered as registration information will be described. As described above, the vein pattern to be a reference is determined when the first resting state is captured and the first registration candidate is determined. Next, when there is input that extends the registration range, a vein pattern corresponding to the input is retained (history) as a registration candidate. Then, if the range is further extended and the range is within the planned registration range (w=wₜₕᵣ), the retained history is updated. Here, while all histories may be retained, it is desirable to update the history in view of memories consumed. Here, since three vein patterns are registered as templates, two vein patterns after the first vein pattern captured in the resting state will be updated.

It is assumed, as shown in FIG. 6, that registration data of the first vein pattern extracted first is I₁ and the position shift amount from the registration data I₁ is d₁¹. In this case, d₁¹=0 applies. Similarly for the subsequently extracted two vein patterns, it is assumed that registration data is I₂ and I₃ and the position shift amount from the registration data I₁ is d₂¹ and d₃¹ respectively.

Since only the first vein pattern is present as a registration information candidate immediately after the resting state is captured, the rotation amount calculation unit 107 measures the position shifts of data (vein pattern) input every moment from the registration data I₁, and the registration information selection unit 109 determines whether or not to add as a registration candidate based on a result notified from the rotation amount calculation unit 107.

When the third vein pattern is added as a registration candidate (I₃), the rotation amount calculation unit 107 measures position shifts from the registration candidates I₁ and I₂. For the position shift from I₁, the position shift itself d₃¹ is retained. For the position shift from I₂, the rotation amount calculation unit 107 calculates d₃² as d₃¹←d₂¹+d₃² based on the position shift amount d₂¹ of I₂ itself from I₁ and the position shift amount d₃² of I₃ from I₂.

When position shifts are measured, instead of measuring only from the peak position of a cross correlation value (correlation coefficient), the position shift amount thereof is adopted only if a similarity is ensured to a certain extent based on the peak value. Thus, the position shift measured value from which registration candidate is adopted depends on how the user moves his (her) finger. In the present embodiment, up to the third registration candidate is mechanically determined, but thereafter, two registration candidates of the three registration candidates will be updated to cover the planned registration range (w=wₜₕᵣ).

Subsequently, the method of updating two vein patterns will be described in detail. In this case, the following two states can be assumed:
(A) The registration range is extended in one direction
(B) The registration range is extended in both directions (to the right and left)

### [When the Registration Range is Extended in One Direction]

First, the case of (A) The registration range is extended in one direction will be described in detail with reference to FIG. 7 to FIG. 9. In this case, for example, as shown in the upper part of FIG. 7, the first vein pattern obtained by capturing the resting state will typically be positioned at one end of the registration range and registration candidates of the second and the third vein patterns are determined in a direction moving away from the first vein pattern.

Here, since the registration range determined by up to the third vein pattern is, as shown in the upper part of FIG. 7, narrower than the threshold (w=wₜₕᵣ) of the registration range, if, as shown in the lower part, of FIG. 7, a fourth or subsequent new candidate is input, it is necessary to take equal spacing of registration candidates into consideration. In this case, while retaining both registration candidates positioned at both ends of the registration range specified by registration candidates of a plurality of vein patterns, the registration information selection unit 109 selects from among registration candidates present inside the registration range those registration candidates positioned in such a way that distances to adjacent registration candidates are close to being substantially equal. That is, in the example shown in the lower part of FIG. 7, among the registration candidates I₁ to I₃ currently retained content of the registration candidates I₂ will be updated by that of a new registration candidate.

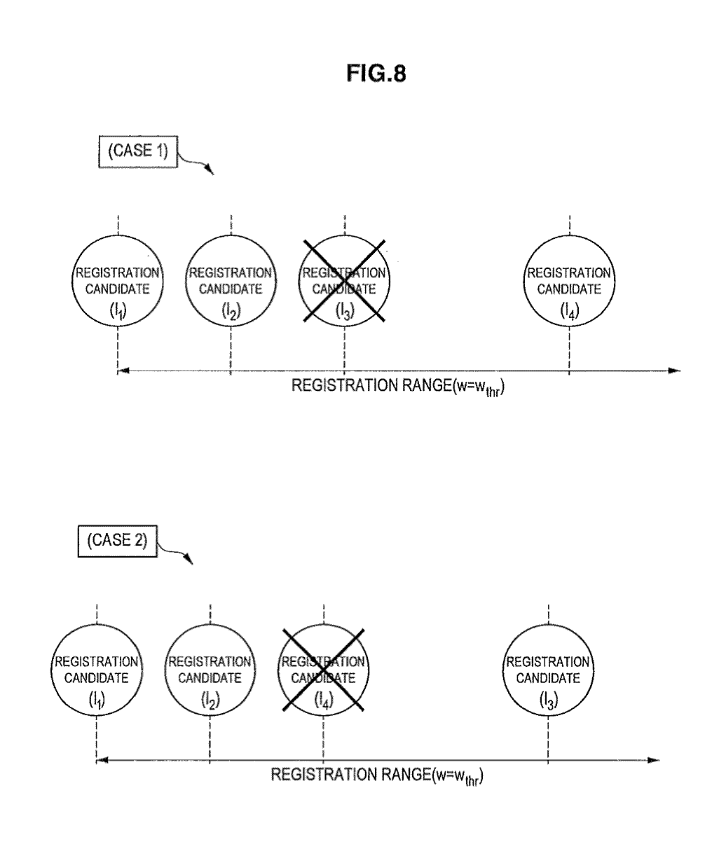

If, when considering equal spacing of registration candidates as described above, registration candidate circumstances in which the registration range is covered based on the candidate selection are compared, unfavorable registration examples may arise, as shown in FIG. 3A and FIG. 3B, depending on the selection of registration candidates. That is, if, as shown in FIG. 8 (Case 1), the history of I₃ is deleted to select I₁, I₃, and I₄ as registration candidates, a dead zone will be generated between I₂ and I₄, which is not desirable. If, as shown in FIG. 8 (Case 2), the history of I₄ is deleted to select I₁, I₂, and I₃ as registration candidates, a dead zone will be generated between I₂ and I₃, which is not desirable.

Thus, the registration information selection unit 109 calculates, when a new candidate is defined as Iₓ, the position shift amount between the new input candidate and each registration candidate so that the registration candidates are assigned equally within the registration range.

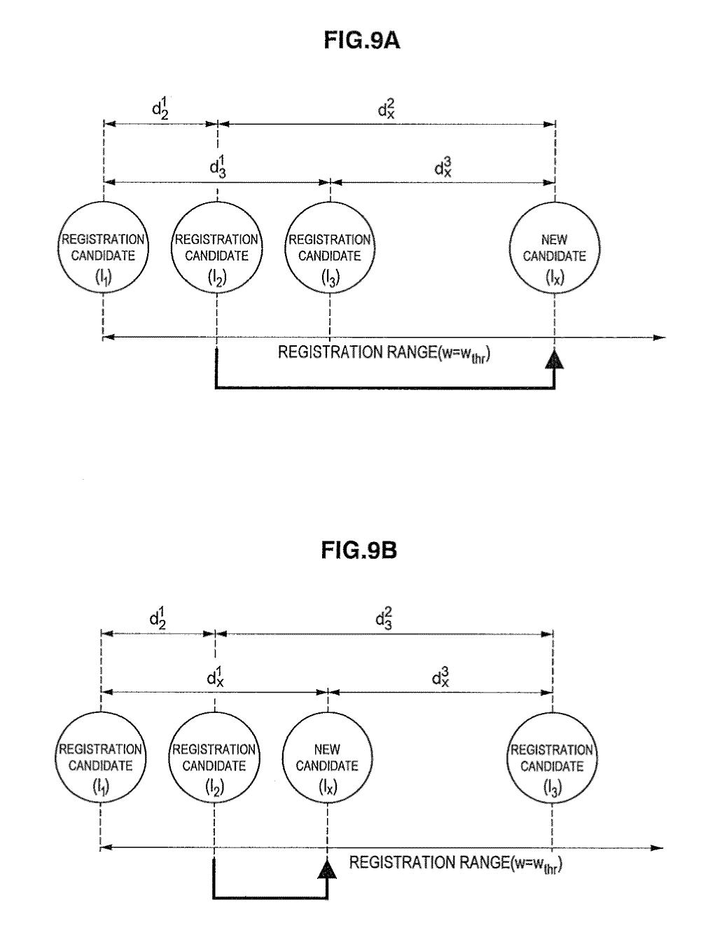

The rotation amount calculation unit 107 first calculates, as shown in FIG. 9A, the position shift amount of the new candidate data Iₓ from each registration candidate and notifies the registration information selection unit 109 of the calculated position shift amount. The registration information selection unit 109 determines among the four registration candidates, while retaining the registration candidate I₁ and the new candidate Iₓ positioned at both ends, which of the registration candidate I₂ and registration candidate I₃ positioned between the registration candidate I₁ and the new candidate Iₓ to select.

The registration information selection unit 109 first examines the registration candidate I₂. When the registration candidate I₂ is left as the center of the registration candidates, whether registration candidate I₂ is arranged equally in the registration range can be known by focusing on Δd₂, which is a difference of position shift amount from I₂. As shown in FIG. 9A, Δd₂, which is a difference of position shift amount from I₂, can foe expressed like (Formula 5) shown below using position shift amounts d₂¹ and dₓ² from I₂.

Similarly, the registration information selection unit 109 examines the registration candidate I₃ by calculating Δd₃, which is a difference of position shift amount from I₃. The registration information selection unit 109 can express Δd₃, which is a difference of position shift amount from I₃, like (Formula 6) shown below using position shift amounts dₓ¹ and dₓ³ from I₃.

Δd₂=|d₂¹−dₓ²| (Formula 5)

Δd₃=|d₃¹−dₓ³| (Formula 6)

A decreasing value of the calculated Ad means that the target registration candidate is positioned closer to the center of the registration range. Thus, if the registration range is extended only in one direction, the vein pattern for which the difference is smaller needs to be left as a registration candidate.

That is, as shown in FIG. 9A, Δd₃ is smaller than Δd₂ and thus, the registration information selection unit 109 updates the history of the registration candidate I₂ and newly selects the registration candidate I₁ the registration candidate I₃ and the new candidate Iₓ as registration candidates.

Further, in the example of extending the registration range in one direction, even if the registration range is not extended by a new candidate, registration candidates need to be updated if the new candidate contributes to an equal arrangement.

That is, as shown in FIG. 9B, if, though the arranged registration range is not extended, the arrangement is made more equal by selecting a new candidate as a registration candidate, registration candidates are updated. In the case shown in FIG. 9B, instead of retaining the history of the registration candidate I₂, distances of adjacent registration candidates are made closer to being substantially equal by retaining a newly input new candidate Iₓ. Thus, the registration information selection unit 109 updates the history of the registration candidate I₂ and newly selects the registration candidate I₁ the registration candidate I₃ and the new candidate Iₓ as registration candidates.

### [When the Registration Range is Extended in Both Directions (to the Right and Left)]

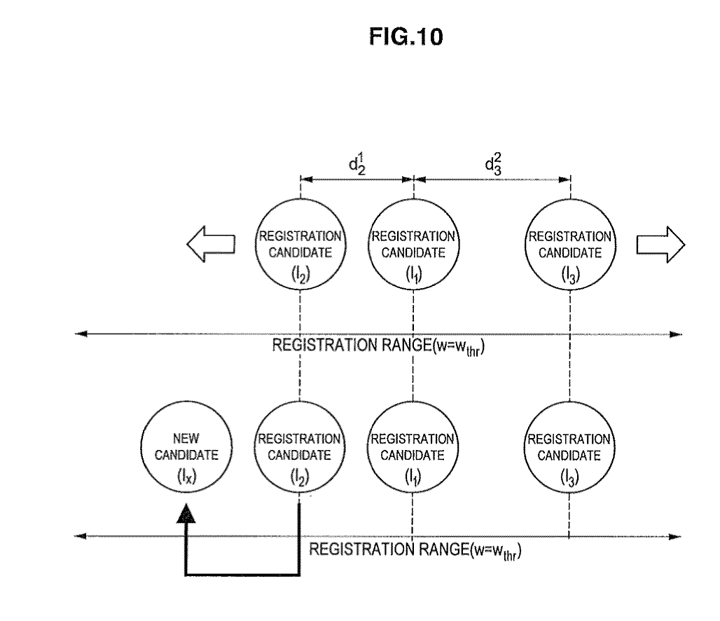

Subsequently, the case of (B) The registration range is extended in both directions (to the right and left) will be described in detail with reference to FIG. 10. When the registration range is extended in both directions (to the right and left), the rotation amount calculation unit 107 first calculates a position shift amount to detect whether the extension direction is the right direction or left direction and notifies the registration information selection unit 109 of a detection result. Based on the notified position shift amount, the registration information selection unit 109 determines whether a position shift amount that extends the registration range has occurred. If a position shift amount that extends the registration range has occurred, the registration information selection unit 109 may update an applicable registration candidate in the detected direction to a new candidate with new data.

That is, in the case shown in FIG. 10, the rotation amount calculation unit 107 calculates that the rotation direction regarding a new candidate is the left direction and the rotation amount, which is the relevant position shift amount, and notifies the registration information selection unit 109 of the rotation direction and position shift amount. The registration information selection unit 109 determines that a position shift amount that extends the registration range has occurred and then updates the registration candidate I₂ to a new candidate Iₓ.

However, when the registration range is extended in both directions (to the right and left), unfavorable registration examples may arise, as shown in FIG. 3A and FIG. 3B. Such a case could arise if a finger slightly rotates in one direction during registration to create one registration candidate and then, the registration range is extended by rotating the finger in the opposite direction only. In this case, like the case when the registration range is extended only in one direction, processing to arrange registration candidates as equally as possible is performed by leaving candidates at both ends of the registration range and removing one of candidates present therebetween as a candidate.

That is, in the case shown in FIG. 10, while retaining the registration candidate I₃ and the new candidate Iₓ, the registration information selection unit 109 calculates Δd for each of the registration candidate I₁ and registration candidate I₂ and selects the registration candidate having a smaller value of Δd. As a result, as is clear from FIG. 10, the registration information selection unit 109 selects the registration candidate I₁ the registration candidate I₃ and the new candidate Iₓ as registration information.

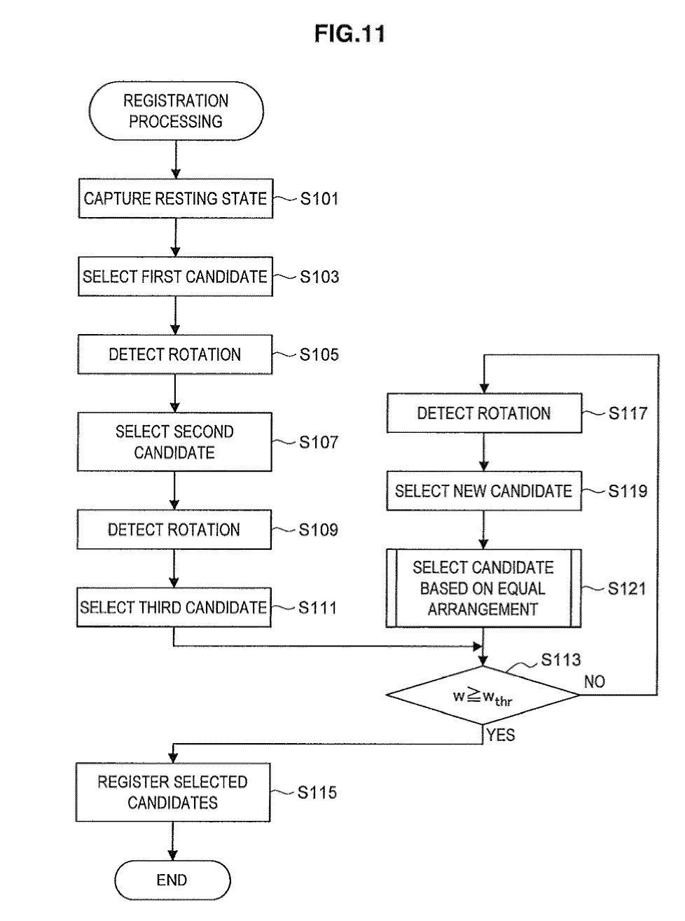

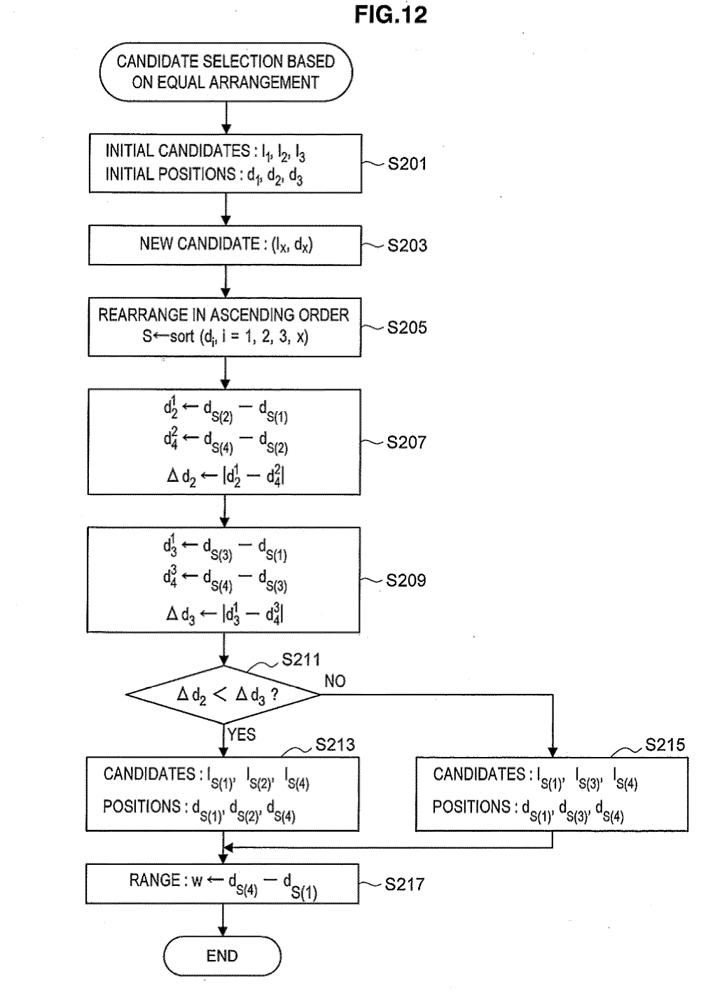

In the foregoing, selection processing of registration information performed by the vein authentication apparatus 10 according to the present embodiment has been described in detail. Subsequently, the vein authentication method (more specifically, registration processing of a template) according to the present embodiment will he described in detail with reference to FIG. 11 and FIG. 12.

### [Description Using a Flow Chart]

FIG. 11 is a flow chart illustrating the vein authentication method according to the embodiment, and FIG. 12 is a flow chart illustrating the selection processing of registration information performed by the rotation amount calculation unit 107 and the registration information selection unit 109.

In the vein authentication method according to the present embodiment, first, registration processing of a vein pattern is started at the time of command selection by a user. After registration processing is started, a display control unit (not shown) of the vein authentication apparatus 10 causes the display unit to display a message to prompt the user to arrange and rest his (her) finger at a predetermined position. Also with the start of registration processing, the light source unit 101 irradiates the position where the finger is arranged with a near infrared light of a predetermined wavelength. If the fact that a finger is arranged and the finger is at rest is captured (S101), the imaging unit 103 images the finger to generate imaged data. Subsequently, the vein pattern extraction unit 105 extracts a vein pattern from the imaged data generated by the imaging unit 103. The extracted vein pattern is sent to the rotation amount calculation unit 107 and, after a position shift amount and the like being calculated, sent to the registration information selection unit 109. The registration information selection unit 109 selects the first sent vein pattern as the first registration candidate (step S103).

After the first registration candidate is selected, the display control unit (not shown) causes the display unit to display, for example, graphics in which a finger rotates or an object to prompt the user to start rotational motion. Since the imaging unit 103 repeatedly images the finger surface at predetermined intervals, the user may freely rotate his (her) finger without being aware of the imaging interval of the vein authentication apparatus 10.

When the second imaged data is generated by the imaging unit 103 after the predetermined interval passes, the vein pattern extraction unit 105 extracts a vein pattern from the second imaged data and sends the vein pattern to the rotation amount calculation unit 107. The rotation amount calculation unit 107 calculates a rotation direction and rotation amount for the second vein pattern (step S105) sent from the vein pattern extraction unit 105 and records the rotation direction and rotation amount in the storage unit 117. Next, the registration information selection unit 109 selects the second vein pattern as registration information (step S107).

Further, when the third imaged data is generated by the imaging unit 103 after the predetermined interval passes, the vein pattern extraction unit 105 extracts a vein pattern from the third imaged data and sends the vein pattern to the rotation amount calculation unit 107. The rotation amount calculation unit 107 calculates a rotation direction and rotation amount for the third vein pattern (step S109) sent from the vein pattern extraction unit 105 and records the rotation direction and rotation amount in the storage unit 117. Next, the registration information selection unit 109 selects the third vein pattern as registration information (step S111).

Here, when three pieces of registration information are selected, the registration information selection unit 109 determines whether or not the registration range w specified by the three pieces of registration information is equal to or more than the threshold wan of the registration range (step S113). If the registration range w is equal to or more than the threshold wₜₕᵣ, the registration information selection unit 109 notifies the imaging unit 103 of the determination result to stop imaging and selects the selected three vein patterns as registration information and notifies the template registration unit 111 of the selected three vein patterns. The template registration unit 111 registers the notified registration information with the storage unit 117 as templates (step S115) and terminates registration processing.

If the registration range w is less than the threshold wₜₕᵣ, the imaging unit 103 images the finger surface to generate the fourth imaged data. Next, the vein pattern extraction unit 105 extracts a vein pattern from the fourth imaged data and sends the vein pattern to the rotation amount calculation unit 107. The rotation amount calculation unit 107 calculates a rotation direction and rotation amount for the fourth vein pattern (step S117) sent from the vein pattern extraction unit 105 and records the rotation direction and rotation amount in the storage unit 117. Next, the registration information selection unit 109 selects the fourth vein pattern as a new candidate (step S119).

Here, the registration information selection unit 109 acquires information about the rotation directions and rotation amounts of three vein patterns selected as the registration candidates and performs selection processing of registration candidates based on information about the rotation direction and rotation amount of the new candidate (step S121). The selection processing will be described again in detail with reference to FIG. 12. When registration candidates to be selected are decided, the registration information selection unit 109 determines the registration range again (step S113).

Subsequently, the flow of selection processing of registration candidates based on the equal arrangement will be described in detail with reference to FIG. 12.

As described above, the registration information selection unit 109 acquires information about the rotation directions and rotation amounts of the first to third registration candidates from the storage unit 117 (step S201). Here, regarding the rotation direction and rotation amount, for example, the amount of rotation that rotates clockwise from the reference position can be expressed as a positive rotation amount and the amount of rotation that rotates counterclockwise from the reference position as a negative rotation amount.

Next, the registration information selection unit 109 acquires also the rotation direction and rotation amount of the new candidate (step S203).

Subsequently, the registration information selection unit 109 rearranges the three registration candidates and one new candidate in ascending order based on the rotation amount (that is, the position shift amount) (step S205). For example, if, as described above, the amount of rotation that rotates clockwise is expressed as a positive rotation amount, the candidates are rearranged in turn from the candidate positioned at the right end to that positioned at the left end.

Subsequently, the registration information selection unit 109 calculates inter-candidate distances d₂¹ and d₄² for a candidate (for example, the candidate positioned second from the right end) positioned inside and then calculates Δd₂ (step S207). Similarly, the registration information selection unit 109 calculates inter-candidate distances d₃¹ and d₄³ for a candidate (for example, the candidate positioned second from the left end) positioned inside and then calculates Δd₃ (step S209).

Next, the registration information selection unit 109 compares the sizes of the calculated Δd₂ and Δd₃ (step S211). If Δd₂ is smaller, the registration information selection unit 109 selects the first, second and fourth candidates as registration information without retaining the third candidate (for example, the third from the right side) (step S213). If Δd₃ is smaller, the registration information selection unit 109 selects the first, third and fourth candidates as registration information without retaining the second candidate (for example, the second from the right side) (step S215).

Subsequently, the registration information selection unit 109 calculates the registration range w based on the rotation amount (position shift amount) of registration information positioned at both ends (step S217).

As described above, due to the vein authentication method (the selection method of registration information) according to the present embodiment, it becomes possible to arrange registration data equally in a range without forcing a user to make a special motion for registration when a template for biometric authentication is registered. Accordingly, vein authentication processing can be performed more steadily. Moreover, by adopting the vein authentication method according to the present embodiment, a registration system that is far easier to use than existing ones can be realized.

### <Update of Registration Information During Authentication Processing>

In the registration method of a template described above, as is evident, from step S113 in FIG. 11, the registration of templates terminates when the registration range w is covered (that is, w≧wₜₕᵣ). This is because if settings are made so that registration does not terminate until all registration candidates are equally arranged, registration processing could become a burden on the user. Thus, when three vein patterns extracted first are selected, there is a possibility that registration processing terminates without a registration selection based on the equal arrangement being made so that an absolute equal arrangement may not be guaranteed.

Thus, it becomes possible to correct during authentication a dead zone that could have been generated during registration by performing update processing of registered templates by using vein patterns used for authentication processing. The update processing of registration information during authentication processing will be described below in detail.

Consider a case in which processing to arrange registration information exactly equally is not performed during registration of templates, position shifts from registered information (templates) are detected during authentication of vein patterns, and authentication is successful. The vein pattern authentication unit 113 has calculated the correlation coefficient and thus, can calculate position shift amounts (that is, the rotation direction and rotation amount) of a vein pattern input for authentication. Thus, if authentication is successful, the vein pattern authentication unit 113 sends the successfully authenticated vein pattern (hereinafter, referred to as authentication information) to the registration information selection unit 109.

After being notified of the authentication information, the registration information selection unit 109 calculates relative position relations of position shift amounts of authentication information and the registration information (templates) currently registered. If the authentication information is closer to the equal arrangement than the registration information currently registered, the registration information selection unit 109 performs the selection processing of registration information to update the template in place of the registered registration information by information (authentication information) presented for authentication.

Note here that a template that extends the registration range should not be updated. If such an update is performed, there is a possibility of a dead zone being extended.

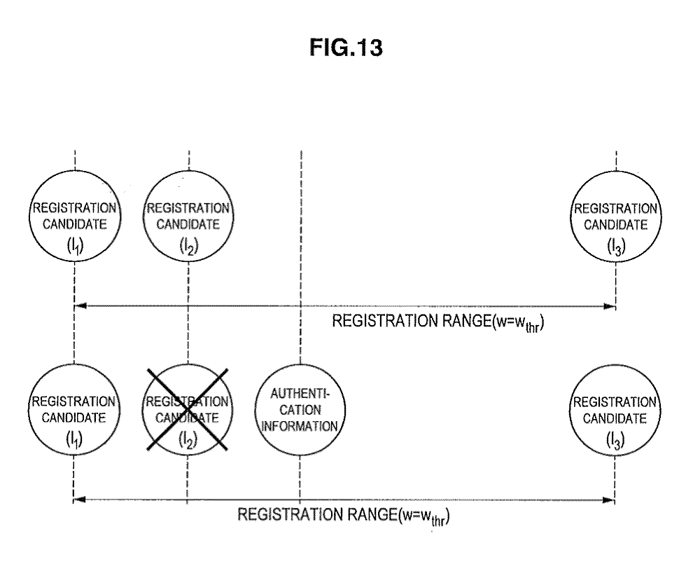

FIG. 13 is an explanatory view illustrating an update of registration information during authentication processing. Consider a case that, as the example shown in the upper part of FIG. 13, registration information I₁ to registration information I₃ have been registered as templates, and a dead zone is generated between the registration information I₂ to registration information I₃. If, in this case, vein authentication processing is performed and the authentication is successful, the vein pattern authentication unit 113 notifies the registration information selection unit 109 of the successfully authenticated vein pattern.

The registration information selection unit 109 first determines whether or not the notified authentication information is present between the registration information I₁ to registration information I₃ in the upper part of FIG. 13. If the notified authentication information is present outside the registration information I₁ or the registration information I₃, the update will extend the registration range as described above, and a dead zone may further be extended.

If the authentication information of which the registration information selection unit 109 is notified is present, for example, at the position shown in the lower part of FIG. 13, this is not a template update that will extend the registration range and thus, the registration information selection unit 109 performs update processing of registration information using the registered registration information I₁ to the registration information I₃ and the notified authentication information. The update processing of registration information is performed in the same procedure as that for selection processing of registration information for registering a template.

If, as a result of update processing, as shown in the lower part of FIG. 13, a more equal arrangement is achieved by the authentication information than the registration information I₂ (in other words, the authentication information is present at a position that makes a dead zone smaller), the registration information selection unit 109 selects the authentication information as registration information, instead of the registration information I₂.

### [Description Using a Flow Chart]

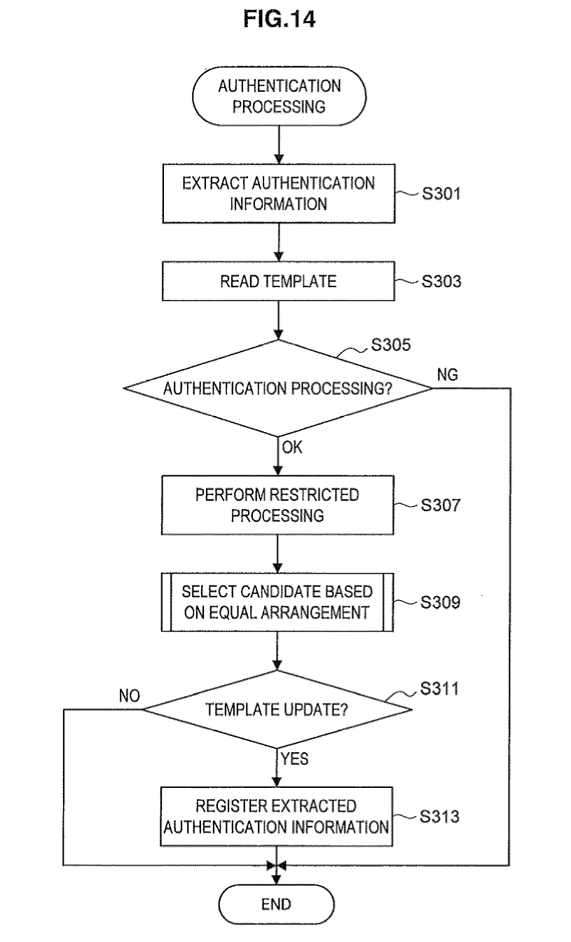

FIG. 14 is a flow chart illustrating an update of registration information during authentication processing.

First, authentication processing itself of a vein pattern is started at the time of command selection by a user. After authentication processing is started, the display control unit (not shown) of the vein authentication apparatus 10 causes the display unit to display a message to prompt the user to arrange and rest his (her) finger at a predetermined position. Also with the start of authentication processing, the light source unit 101 irradiates the position where the finger is arranged with a near infrared light of a predetermined wavelength. Then, the imaging unit 103 images the finger to generate imaged data. Subsequently, the vein pattern extraction unit 105 extracts a vein pattern from the imaged data generated by the imaging unit 103 (step S301). The vein pattern authentication unit 113 is notified of the extracted vein pattern.

The vein pattern authentication unit 113 first reads templates recorded in the storage unit 117 (step S303) and compares the registered templates and the extracted vein pattern. More specifically, the vein pattern authentication unit 113 calculates a correlation coefficient shown in (Formula 4) and determines whether or not the obtained correlation coefficient exceeds a predetermined threshold (step S305). If the correlation coefficient is less than the predetermined threshold, the vein pattern authentication unit 113 determines that the extracted vein pattern is not similar to the registered templates and authentication has failed.

If the obtained correlation coefficient is equal to or more than the predetermined threshold, the vein pattern authentication unit 113 determines that the extracted vein pattern is similar to the templates and authentication is successful.

If authentication is successful, the vein pattern authentication unit 113 notifies the restricted processing execution unit 115 of successful authentication, and the restricted processing execution unit 115 performs processing whose execution is restricted (step S307).

If authentication is successful, the vein pattern authentication unit 113 notifies the registration information selection unit 109 of the successfully authenticated vein pattern (authentication information), and the registration information selection unit 109 makes a candidate selection based on the equal arrangement (step S309). More specifically, a determination is made that the notified authentication information is not present at a position that extends the registration range and then, update processing of registration information is performed according to the flow chart shown in FIG. 12.

If, as a result of update processing of registration information, the authentication information is selected in place of the registered registration information, the registration information selection unit 109 notifies the template registration unit 111 of the selection result, and the template registration unit 111 registers the authentication information as new registration information (step S313). If the authentication information is not selected as new registration information, the template registration unit 111 terminates processing without updating templates.

By performing update processing of registration information during authentication in the manner, templates are updated to decrease a dead zone also during authentication when necessary so that templates can reach a higher degree of maturity each time authentication is performed.

In the above description of each embodiment of the present invention, a case in which three vein patterns are registered as registration information is described, but similar processing can be performed when four or more vein patterns are selected as registration information. That is, while retaining vein patterns positioned at both ends of the registration range, distances to other vein patterns are calculated for each of vein patterns positioned inside and those vein patterns that produce substantially equal distances to adjacent ones can be selected as registration candidates.

### <Hardware Configuration>

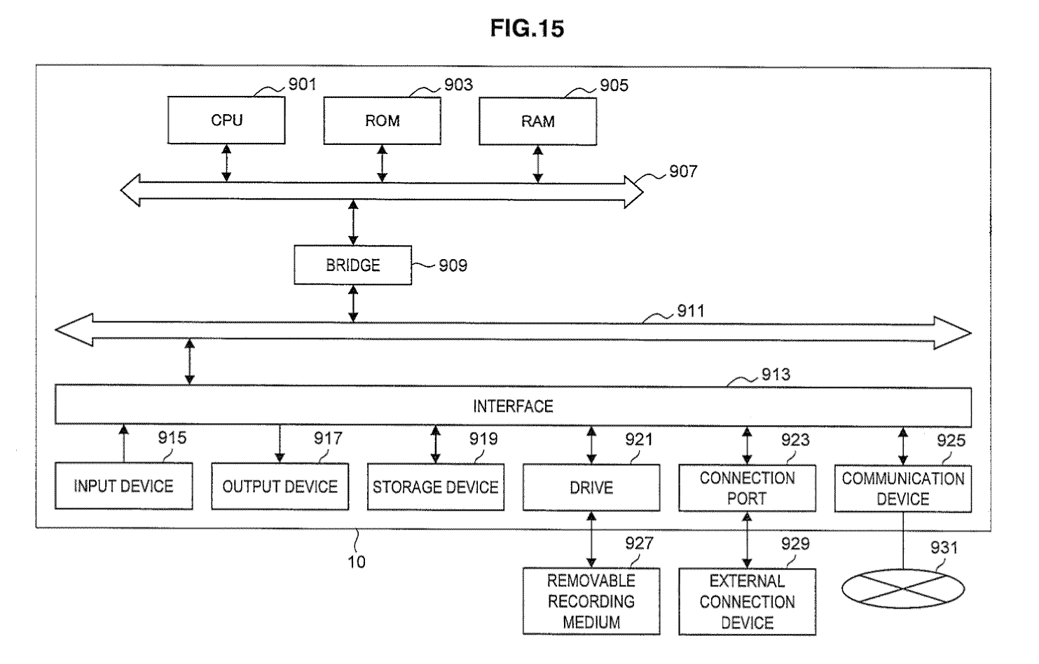

Next, the hardware configuration of the vein authentication apparatus 10 according to each embodiment of the present invention will be described in detail with reference to FIG. 15. FIG. 15 is a block diagram illustrating the hardware configuration of the vein authentication apparatus 10 according to the present embodiment.

The vein authentication apparatus 10 includes mainly a CPU 901, a ROM 903, a RAM 905, a host bus 907, a bridge 909, an external bus 911, an interface 913, an input device 915, an output device 917, a storage device 919, a drive 921, a connection port. 923, and a communication device 925.

The CPU 901 functions as an arithmetic processing unit and a control device and controls overall operations in the vein authentication apparatus 10 or a portion thereof according to various programs recorded in the ROM 903, the RAM 905, the storage device 919, or a removable recording medium 927. The ROM 903 stores programs, arithmetic parameters and the like used by the CPU 901. The RAM 905 temporarily stores programs used for execution by the CPU 901, parameters that appropriately change in execution thereof and the like. These components are mutually connected by the host but 907 formed by an internal bus such as a CPU bus.

The host but 907 is connected to the external bus 911 such as a PCI (Peripheral Component Interconnect/Interface) bus via the bridge 909.

The input device 915 is an operation unit operated by a user such as a mouse, keyboard, touch panel, button, switch, and lever. The input device 915 may also be, for example, a remote control unit using an infrared light or other electric waves or an external connection device 929 such as a mobile phone and PDA conforming to operations of the vein authentication apparatus 10. Further, the input device 915 includes an input control circuit that generates an input signal based on information input by the user using, for example, the above operation unit and outputs the input signal to the CPU 910. The user of the vein authentication apparatus 10 can input various kinds of data to the vein authentication apparatus 10 and instruct processing operations by operating the input device 915.

The output device 917 includes, for example, a display device such as a CRT display device, liquid crystal display device, plasma display device, EL display device, and lamp, a sound output device such as a speaker and headphone, and a device capable of visually or orally notifying the user of acquired information such as a printer, mobile phone and facsimile. The output device 917 outputs, for example, results obtained by various kinds of processing performed by the vein authentication apparatus 10. More specifically, a display device displays results obtained by various kinds of processing performed by the vein authentication apparatus 10 as text or images. On the other hand, a sound output device converts an audio signal such as reproduced voice data and acoustic data into an analog signal and outputs the analog signal.

The storage device 919 is a device for data storage configured as an example of the storage unit of the vein authentication apparatus 10 and includes, for example, a magnetic storage device such as an HDD (Hard Disk Drive), semiconductor storage device, optical storage device, and magneto-optical device. The storage device 919 stores programs executed by the CPU 910, various kinds of data, and various kinds of data acquired from outside.

The drive 921 is a reader/writer for recording media and is contained in the vein authentication apparatus 10 or externally connected. The drive 921 reads information recorded in the inserted removable recording medium 927 such as a magnetic disk, optical disk, magneto-optical disk and semiconductor memory and outputs the information to the RAM 905. The drive 921 can also write records into the inserted removable recording medium 927 such as a magnetic disk, optical disk, magneto-optical disk and semiconductor memory. The removable recording medium 927 is, for example, a DVD medium, HD-DVD medium, Blu-ray medium, CompactFlash (CF) (registered trademark), memory stick, or SD memory card (Secure Digital memory card). The removable recording medium 927 may be, for example, an IC card (Integrated Circuit card) on which a non-contact IC chip is mounted or electronic device.

The connection port 923 is a port to directly connect a device to the vein authentication apparatus 10 such as USB (Universal Serial Bus) port, IEEE 1394 port such as i. Link, SCSI (Small Computer System Interface) port, RS-232C port, optical audio terminal, and HDMI (High-Definition Multimedia Interface) port. By connecting the external connection device 929 to the connection port 923, the vein authentication apparatus 10 directly acquires various kinds of data from the external connection device 929 and provides various kinds of data to the external connection device 929.

The communication device 925 is a communication interface configured, for example, by a communication device for connecting to a communication network 931. The communication device 925 is, for example, a wire or wireless LAN (Local Area Network), communication card for Bluetooth or WUSB (Wireless USB), router for optical communication, router for ADSL (Asymmetrical Digital Subscriber Line), or modem for various kinds of communication. The communication device 925 can transmit/receive signals and the like according to a predetermined protocol such as TCP/IP to/from the Internet and other communication devices. The communication network 931 connected to the communication device 925 is configured by networks or the like connected by wire or wireless and may be, for example, the Internet, family LAN, infrared ray communication, radiofrequency wave communication, or satellite communication.

In the foregoing, an example of the hardware configuration capable of realizing the functions of the vein authentication apparatus 10 according to each embodiment of the present invention is shown. Each of the above components may be constructed by using general-purpose members or hardware tailored to the function of each component. Therefore, the hardware configuration to be used can be changed when necessary in accordance with the technical level when the present embodiment is carried out.

Incidentally, the vein authentication apparatus 10 according to each embodiment of the present invention can be provided as a program having functions shown below. The program is a program to cause a computer to realize a light source unit control function to control a light source unit that irradiates a surface of a finger making a rotational motion around an axis along a length direction with a near infrared light of a predetermined wavelength, an imaging control function to control an imaging unit that images the surface of the finger irradiated with the near infrared light at predetermined intervals to generate a plurality of pieces of vein imaged data whose imaging range is mutually different, a vein pattern extraction function to extract a vein pattern from each of the plurality of pieces of vein imaged data, a rotation amount calculation function to calculate a rotation direction and a rotation amount of the finger accompany in g the rotational motion of each of the extracted vein patterns relative to the imaging range of one of the vein patterns, and a registration information selection function to select the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.

The computer program is stored in the storage unit provided with a computer and causes the computer to function as the vein authentication apparatus 10 by being read and executed by the CPU provided with the computer. Further, a computer readable recording medium in which the computer program is recorded can be provided. The recording medium is, for example, a magnetic disk, optical disk, magneto-optical disk, or flash memory. The computer program may also be delivered, for example, via a network without using a recording medium.

The present application contains subject matter related to that disclosed in Japanese Priority Patent Application JP 2008-133484 filed in the Japan Patent Office on May 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A vein authentication apparatus, comprising:
a light source unit that irradiates a surface of a finger making a rotational motion around an axis along a length direction with a near infrared light of a predetermined wavelength;
an imaging unit that images the surface of the finger irradiated with the near infrared light at predetermined intervals to generate a plurality of pieces of vein imaged data whose imaging range is mutually different;
a vein pattern extraction unit that extracts a vein pattern from each of the plurality of pieces of vein imaged data;
a rotation amount calculation unit that calculates a rotation direction and a rotation amount of the finger accompanying the rotational motion of each of the extracted vein patterns relative to the imaging range of one of the vein patterns; and
a registration information selection unit that selects the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.

2. The vein authentication apparatus according to claim 1, wherein the registration information selection unit retains the vein patterns positioned at both ends of the imaging range and selects from among the vein patterns present between the vein patterns positioned at both ends the vein patterns positioned in such a way that distances to the adjacent vein patterns are close to being substantially equal.

3. The vein authentication apparatus according to claim 2, further comprising a vein pattern authentication unit that authenticates the extracted vein pattern based on the registration information registered as the template, wherein
the registration information selection unit updates content of the registered registration information using the registration information and the authenticated vein pattern.

4. The vein authentication apparatus according to claim 1, wherein the rotation amount calculation unit calculates correlation coefficients between the one vein pattern to be the reference and the other vein patterns to calculate the rotation direction and the rotation amount based on a shift direction and the shift amount of a peak position of the correlation coefficients.

5. The vein authentication apparatus according to claim 1, wherein the threshold of the shift width of the imaging range is 10% of a pixel amount representing the imaging range of the one vein pattern to be the reference.

6. A vein authentication method, comprising the steps of:
irradiating a surface of a finger making a rotational motion around an axis along a length direction with a near infrared light of a predetermined wavelength;
imaging the surface of the finger irradiated with the near infrared light at predetermined intervals to generate a plurality of pieces of vein imaged data whose imaging range is mutually different;
extracting a vein pattern from each of the plurality of pieces of vein imaged data;
calculating a rotation direction and a rotation amount of the finger accompanying the rotational motion of each of the extracted vein patterns relative to the imaging range of one of the vein patterns; and
selecting the vein pattern to be registered as a template from a plurality of the vein patterns to make the vein pattern registration information if, after calculating a shift amount of the imaging range based on the rotation direction and the rotation amount and determining whether or not a shift width of the imaging range is equal to or more than a predetermined threshold, the shift width of the imaging range is less than the predetermined threshold.
